(19) United States
(12) Patent Application Publication
(10) Pub. No.: US 2012/0108342 A1
(43) Pub. Date: May 3, 2012

(54) GAME UNIT FOR ELECTRONIC DEVICES

(75) Inventors: Elliot Rudell, Torrance, CA (US); George T. Foster, Placerville, CA (US); Julio Sandoval, Long Beach, CA (US)

(73) Assignee: Rudell Design LLC

(21) Appl. No.: 13/230,712

(22) Filed: Sep. 12, 2011

Related U.S. Application Data
(60) Provisional application No. 61/407,825, filed on Oct. 28, 2010.

(51) Int. Cl. A63F 9/24; A63F 13/06

(52) U.S. Cl. 463/42; 463/37

(57) ABSTRACT

A game unit for an electronic device. The game unit includes a tray adapted to receive the electronic device so that a display surface of said electronic device is in a horizontal position. The game unit also includes a plurality of input devices and a communication device that couples the input devices to the electronic device. Multiple users may provide input, individually or simultaneously, for the game through the input devices of the game unit. The game unit thus expands the number of players for a game operated by a portable electronic device.

### CROSS-REFERENCE TO RELATED APPLICATIONS

This application claims priority to Application No. 61/407,825 filed on Oct. 28, 2010.

### BACKGROUND OF THE INVENTION

1. Field of the Invention

The present invention relates to a game unit that can be coupled to an existing electronic game.

2. Prior Art

There have been marketed and sold numerous electronic devices that can be used to play games. For example, Nintendo Co., Ltd. sells a product under the trademark Wii that connects to a visual display and allows a user to play a game by manipulating a hand held controller. A second player may participate, but that person must also manipulate a hand held controller. The requirement for multiple controllers can limit participation in a game.

There have also been marketed various electronic devices such as cell phones and tablets that allow for game play. For example, Apple Inc. has sold cell phones and tablets under the iPhone and iPad trademarks, respectively. iPhones and iPads allow users to load game applications. Generally speaking, cell phones and tablets can only be used by one person at a time, thereby limiting the types of games that can be played with these devices. When multiple players are involved, the typical sequence of play includes game play by one player who then passes the unit to the next player.

There has been marketed a docking station under the name GRIFFIN PARTY DOCK that can be coupled to a portable device such as a cell phone or an electronic tablet. The portable device is mounted in a manner that is essentially perpendicular to the docking station. The station includes four wireless controllers that can be manipulated by users to enter instructions, etc. to the portable device through the docking station. This arrangement precludes the appearance or interaction of the tablet as an integral gameboard element as would be appreciated by users of typical board games, where activity is flat on the ground, centered in the middle of a table; and visible to all members sitting around such a table.

### BRIEF SUMMARY OF THE INVENTION

A game unit for an electronic device. The game unit includes a tray adapted to receive the electronic device so that a display surface of said electronic device is in a horizontal position. The game unit also includes a plurality of input devices coupled to said tray, and a coupling device that couples the input devices to the electronic device.

### BRIEF DESCRIPTION OF THE DRAWINGS

FIG. 1 is an illustration of an electronic device inserted into a game unit;

FIG. 2 is an illustration of the game unit without the electronic device;

FIG. 3 is an illustration showing electronic components of the game unit;

FIG. 4 is an illustration similar to FIG. 1 showing an input device rotated into a concealed position;

FIG. 5 is an illustration showing an input device removed from a tray;

FIG. 6 is an illustration of an alternate embodiment of the game unit;

FIG. 7 is an illustration showing the electronic device being tilted through manipulation of an input device;

FIG. 8 is an illustration showing a game unit with an insert used for a smaller electronic device;

FIG. 9 is an illustration showing an alternate embodiment of the game unit tray;

FIG. 10 is an illustration showing another alternate embodiment of the game unit tray; and,

FIG. 11 is an illustration of an alternate embodiment of the game unit with a lamp coupled to a camera of the electronic device.

### DETAILED DESCRIPTION

Disclosed is a game unit for an electronic device. The game unit includes a tray adapted to receive the electronic device so that a display surface of said electronic device is in a horizontal position. The game unit also includes a plurality of input devices and a communication device that couples the input devices to the electronic device. By way of example, a tablet such as the Apple iPad may be coupled to or inserted into the tray. The tablet may provide and operate a game. Multiple users may provide input, individually or simultaneously, for the game through the input devices of the game unit. The game unit thus expands the number of players for a game operated by a portable electronic device.

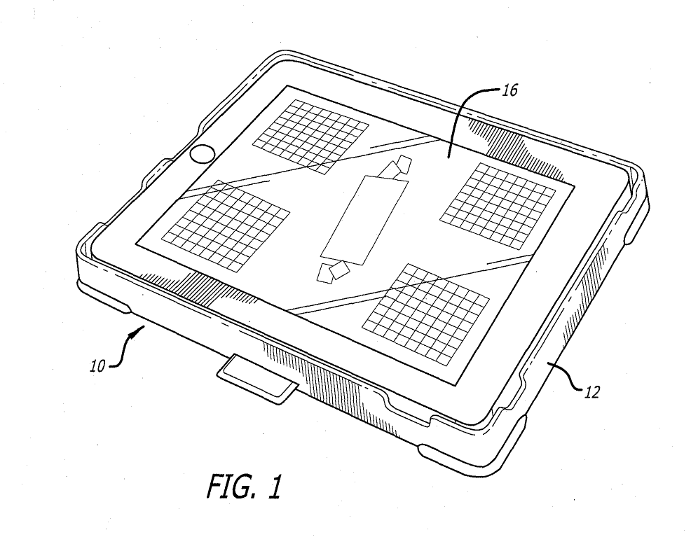

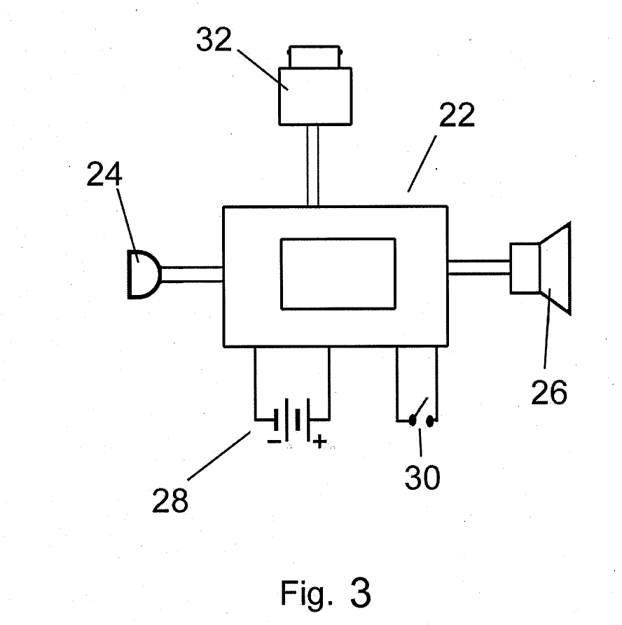

Referring to the drawings by reference numbers, FIGS. 1, 2 and 3 show an embodiment of a game unit 10. The game unit 10 includes a tray 12 with a designated location such as an insert cavity 14 that can receive an electronic device 16. The electronic device 16 may be any type of device that allows a user to play a game, and preferably provides a visual display. By way of example, the device 16 may be an electronic tablet such as the iPad sold by Apple Inc. Likewise, cell phones such as the iPhone sold by Apple Inc. can be utilized with the game unit 10. Other commercially available devices may be inserted onto or into the tray 12 of the game unit 10, such as a Wii controller (which does not provide a display) sold by Nintendo Co., Ltd. or a PSP play station controller sold by Sony Corp. These products are merely provided as examples of the types of electronic devices that can be utilized with the game unit 10. It is to be understood that other devices may be inserted into or onto the game unit 10.

The game unit 10 may be constructed from a molded material such as injection molded ABS, or high impact styrene. The tray 12 dimensions may be such that tray walls 18 apply a pressure to the electronic device 16 to keep the device in place. The tray walls could be adjustable in position to provide such pressure. The tray 12 may include other attachment features such as straps, or hook and loop material, or adhesive that capture the electronic device 16. Alternatively, the electronic device 16 may also be removably coupled to the tray 12 by being placed on a designated flat surface that is either molded with a non-skid surface, or to which a special non-skid material, such as a dimpled rubber mat, has been affixed. This would maintain the position of the device 16 while providing for its immediate removal if so desired.

The game unit 10 includes a plurality of input devices 20. Each input device 20 may include a button or touch pad that can be depressed by a user. Although a single touch pad is shown, it is to be understood that each input device 20 may have multiple input elements. For example, each input device 20 may include three separate buttons that allow a player to input, for example, YES, NO or PASS.

The input devices 20 are coupled to a printed circuit board 22 in the game unit 10. The printed circuit board 22 may be connected to a microphone 24 and a speaker 26. All of the electrical components may be powered by a battery(ies) 28 connected to an ON/OFF switch 30. The printed circuit board 22 may include electrical circuits that can process input from the input devices 20 and transmit the inputs to the electronic device 16, in either a wired or wireless manner. By way of example, the printed circuit board 22 may include a transceiver that can wirelessly transmit signals to the device 16 in accordance with WiFi or Bluetooth protocol. The transmitted signals are processed by the electronic device 16 in accordance with the operation of a game. The transceiver may also receive signals from the electronic device. Such signals may for example, cause sound to be emitted from the speaker 26, or lights to activate. The circuit board 22 may be directly connected to the electronic device 16 by an electrical connector 32.

The game unit 10 allows multiple players to participate in a game operated by the electronic device 16. By way of example, the electronic device 16 may operate a game wherein a letter is displayed by the device 16. The first player to press their input device 20 would “own” the letter. The game could then require that player to enter input through their input device, or touch the screen of the game unit 16, to move the letter into a section of the screen adjacent to the player. The user can then enter another input to lock the letter into place. This sequence may be repeated wherein players construct words with the letters. A winner may be the person who spelled the most correct words. The electronic device 16 may incorporate a timer that is associated with game play. The electronic device 16 may perform a game that operates in accordance with oral input that is received through the microphone 24 as players speak. In this embodiment, a speech recognition application would be required of the electronic device 16.

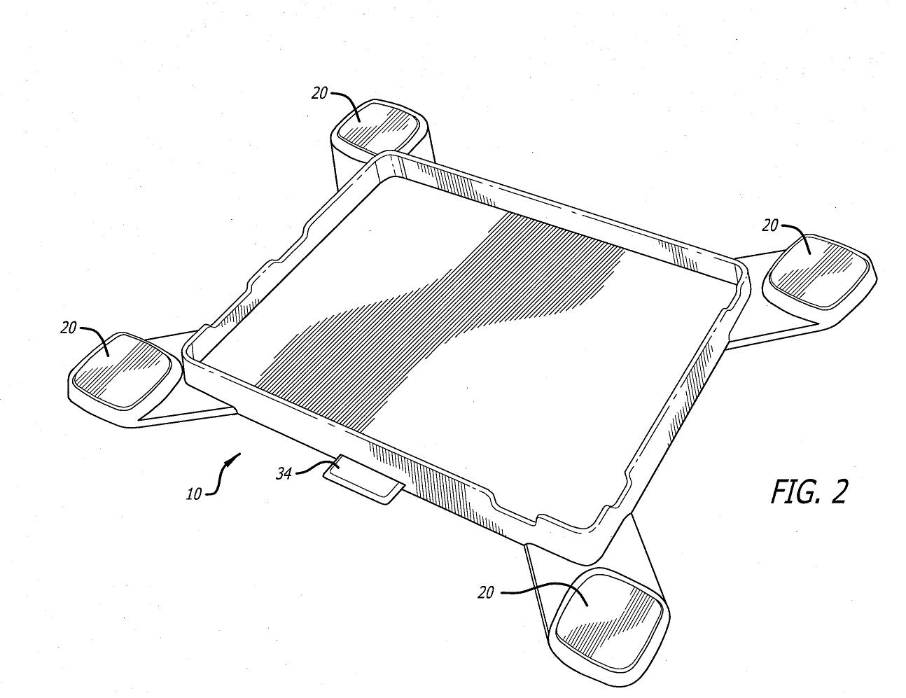

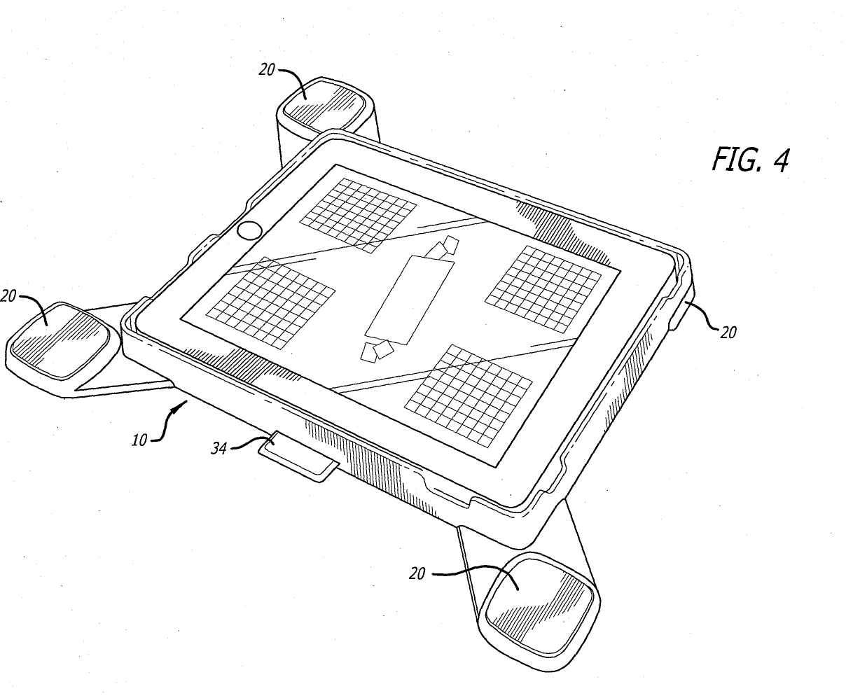

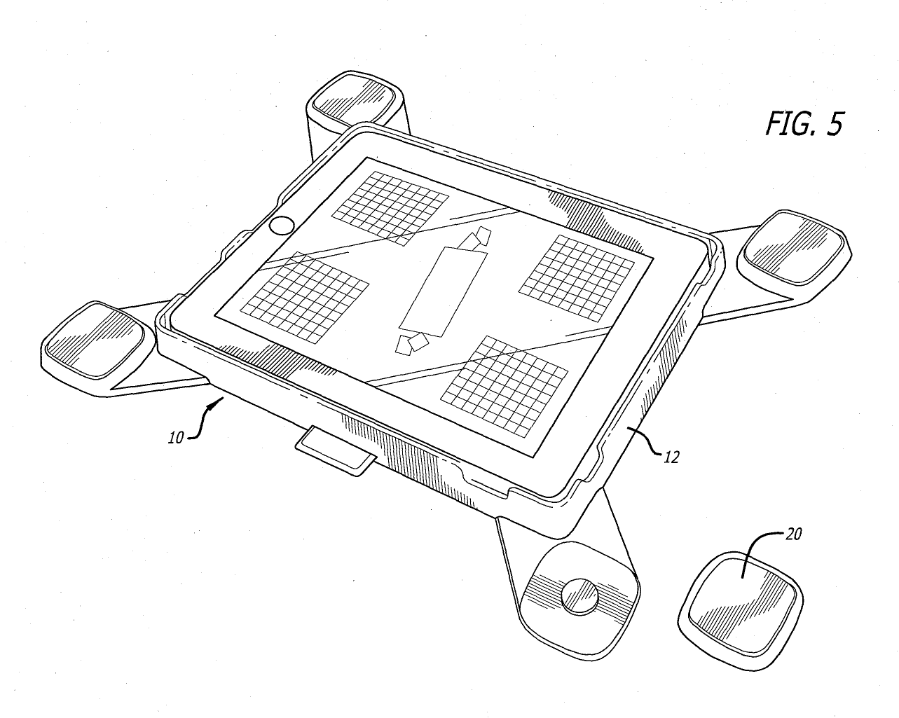

The input devices 20 can be rotated between concealed and exposed positions. The game unit 10 may include an input button 34 that can be pushed to cause the input devices 20 to move into the exposed position shown in FIG. 2a. As shown in FIG. 4, the input devices 20 may be individually adjustable so that one or more of the devices 20 can be moved back into the concealed position, in the event less than four players were playing the game. Although four input devices 20 are shown, it is to be understood that the game unit 10 may have any number of input devices 20. As shown in FIG. 5, each input device 20 can be removed from the tray 12 and be in wireless communication with the printed circuit board (not shown).

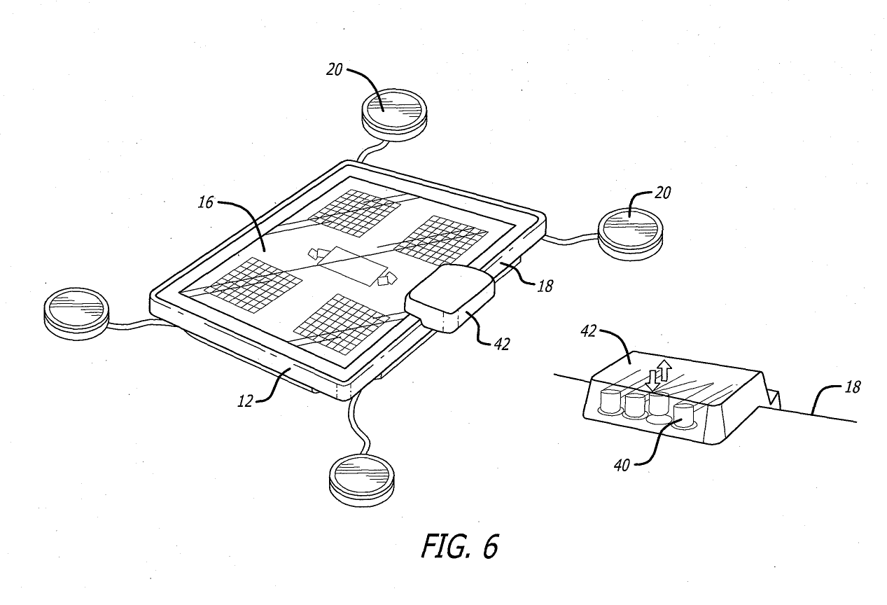

FIG. 6 shows an alternate embodiment of the game unit wherein communication to the electronic device 20 is provided through a plurality of mechanical probes 40 that make contact with a touch screen of the device 16. The probes 40 may be actuated by electric motor, solenoids or other devices (not shown) that can move the probes 40 into contact with the electronic device 16. To work with capacitance-activated touchscreen devices 16, the probes 40 could provide capacitance input. Other devices do not require capacitance to receive input, but instead receive input via pressure-touch. The probes 40 can provide such pressure input. The position of a particular probe on the surface of the electronic device 16 could translate to unique responses and inputs. A motor or solenoid to activate said probes could be connected to the printed circuit board of the game unit. The probes 40 may be located within a case 42 that can slide along the walls 18 of the tray 12. The case 42 can be manually moved about the tray and/or can be automated to be moved by a motor or other movement device.

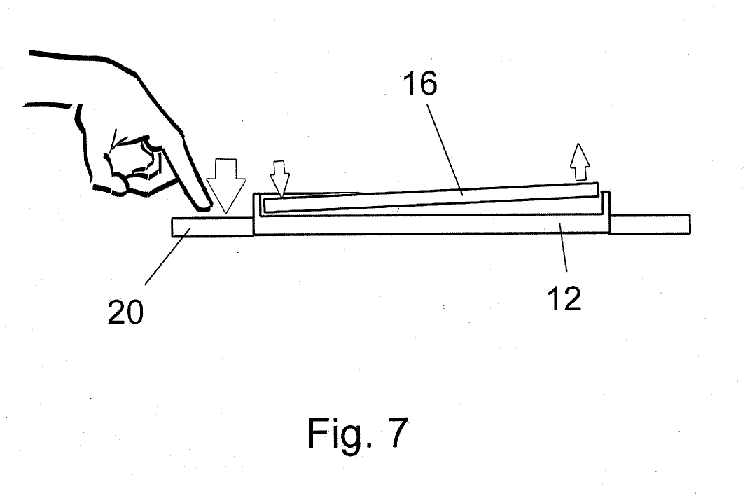

FIG. 7 shows an embodiment wherein the electronic device 16 is tilted by depressing one of the input devices 20. Certain electronic devices 16 include motion sensors such as an accelerometer that can sense movement of the device 16. The tray 12 may include a lever or mechanical arm that tilts the electronic device 16 when the input device 20 is pressed by a user. This may induce a game play such as causing a graphical ball to roll across a graphical surface.

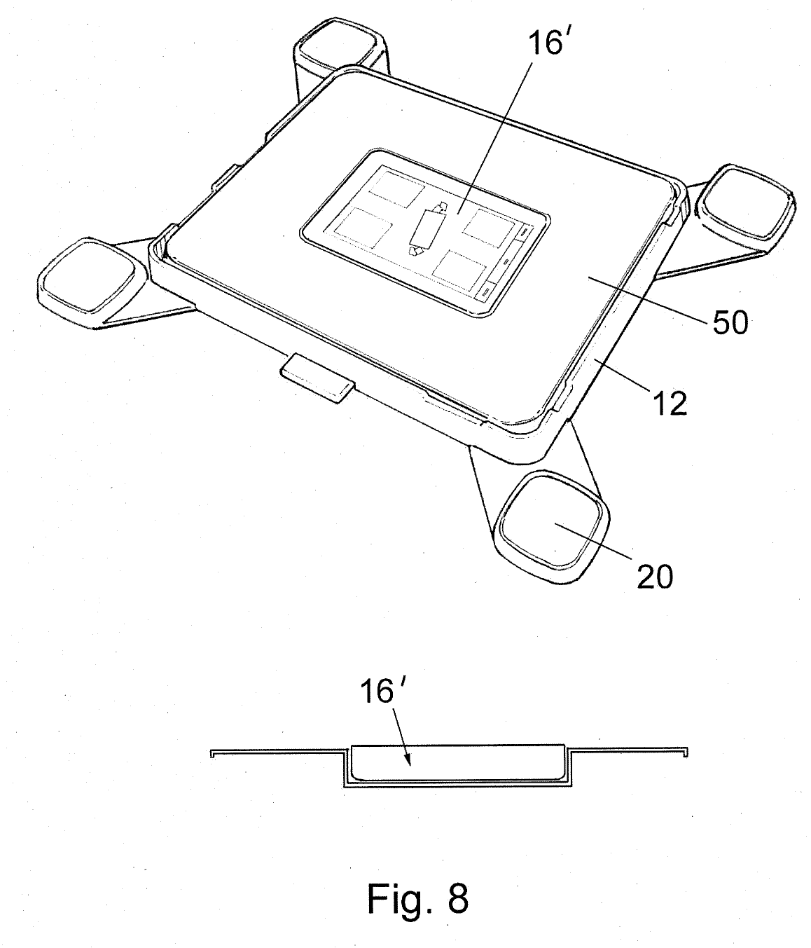

FIG. 8 shows an insert 50 added to the tray 12. The insert 50 may be utilized to capture smaller electronic devices 16′ such as cell phones. The insert 50 may exert a pressure onto the electronic device 16′ to capture the device 16′. Alternatively, non-skid materials, or adhesive materials, as described earlier, could be used to couple smaller devices to the game unit.

Referring to FIG. 1, the electronic device 16 may display a plurality of game play areas 60. An input device 20 is associated with each game play area 60. By way of example, each game play area 60 may simulate a “scrabble-like” word game board. Each input device 20 can be manipulated to enter graphical letters onto the scrabble board. The horizontal orientation of the electronic device 16 relative to the tray 12 allows the device 16 to more readily simulate a game board.

Each input device 20 may provide a unique identification code that is unique to each device 20 so that the circuit board can differentiate between the different devices. Alternatively, the output and ID for each input device 20 may be provided directly to the electronic device 16.

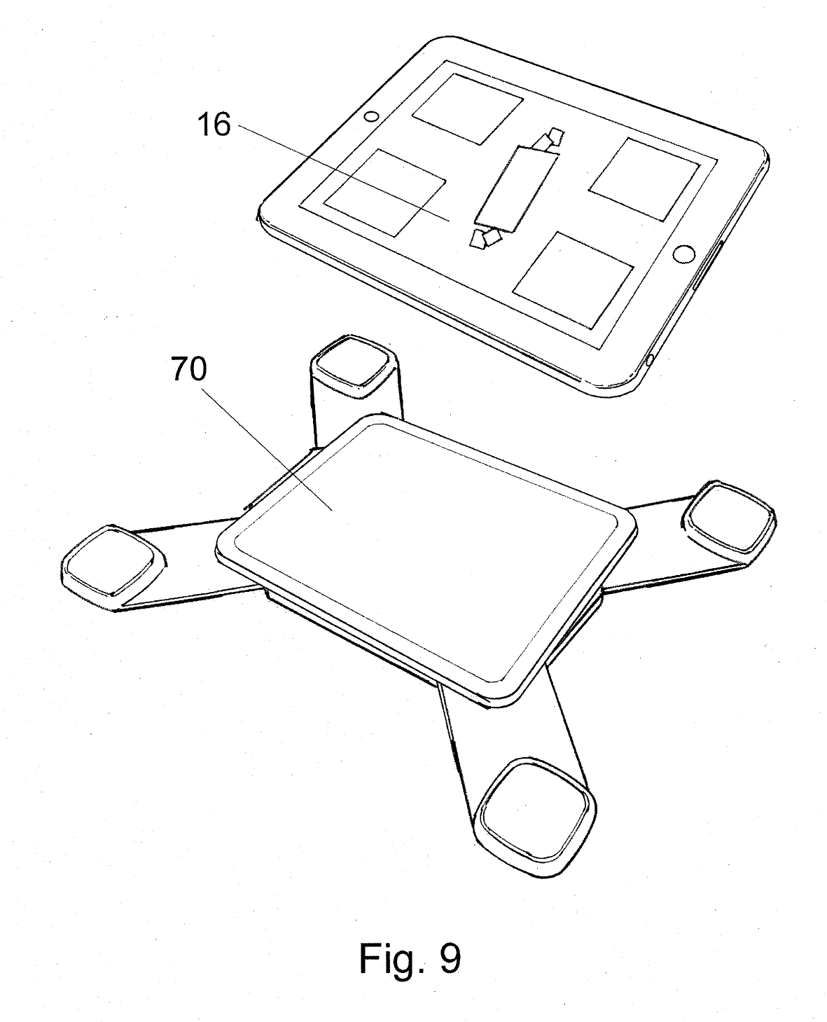

FIG. 9 shows an alternate embodiment of tray 70 that does not have walls that extend up around the electronic device. The tray 70 could have a surface such as a dimpled mat, Velcro, etc. that can maintain the position of the electronic device 16.

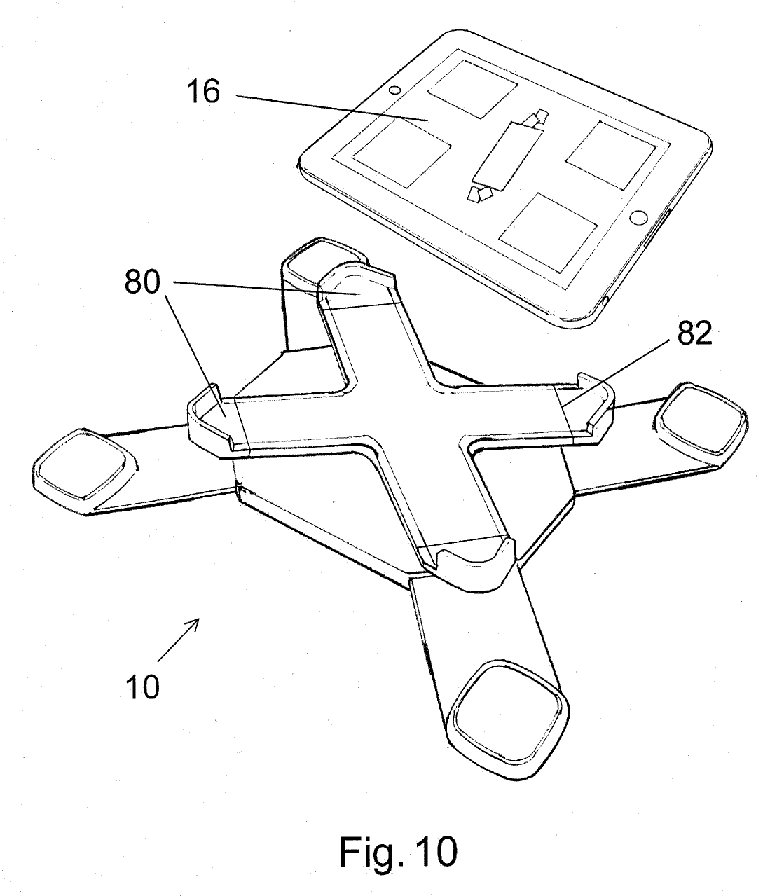

FIG. 10 is another alternate embodiment of a cross shaped tray 80 with four different walled areas that can captured the electronic device 16. Such an embodiment may be lighter in weight than a full tray as shown in FIG. 1. The walled areas may be adjustable to accommodate different size electronic devices.

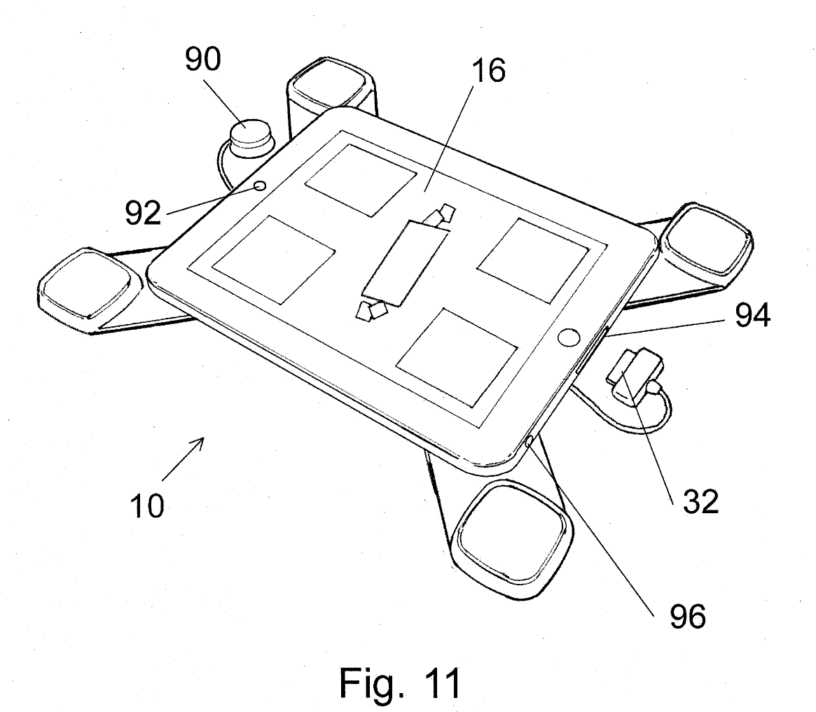

FIG. 11 shows another embodiment that includes a lamp 90 located over a camera 92 of the electronic device. The lamp 90 may be connected to the circuit board and generated light that is detected by the camera. The lamp 90 may be capable of generating different colors of light. Each color can be associated with one of the input devices.

FIG. 11 also shows the connector 32 which can be connected to a data port 94 of the electronic device. The data port may be a 32-pin port. The circuit board can also be connected directly to the electronic device 16 by a plugging a jack (not shown) into an audio jack 96 of the device 16.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

Although communication between the game unit 10 and electronic device 16 have been described with wireless signals or mechanical probes, it is to be understood that other forms of communication can be employed. For example, visible or invisible light may be utilized to communicate with the electronic device.

What is claimed is:

1. A game unit for an electronic device, comprising:
a tray adapted to receive the electronic device so that a display surface of said electronic device is in a horizontal position;
a plurality of input devices coupled to said tray; and,
a coupler that couples said input devices to the electronic device.

2. The game unit of claim 1, wherein said tray includes a plurality of walls.

3. The game unit of claim 1, wherein said input devices can be rotated between an exposed position and a concealed position.

4. The game unit of claim 3, wherein said tray includes an input button that can move said input devices to the exposed position.

5. The game unit of claim 1, wherein said coupler includes a connector that is connected to a data port of the electronic device.

6. The game unit of claim 5, wherein said data port is a 32-pin input.

7. The game unit of claim 1 wherein said coupler includes a jack that is plugged into an audio port of the electronic device.

8. The game unit of claim 1, wherein said coupler includes a wireless receiver.

9. The game unit of claim 1, wherein said coupler includes mechanical elements that can come into contact with the electronic device.

10. The game unit of claim 1, wherein said input devices include touch pads.

11. The game unit of claim 1, further comprising an insert located within an insert cavity of said tray.

12. The game unit of claim 1, wherein said coupler includes a lamp.

13. A game unit for an electronic device, comprising:
a tray adapted to receive the electronic device so that a display surface of said electronic device is in a horizontal position;
input means for allowing a plurality of users to provide input for the electronic device; and,
communication means for communicating the users' inputs to the electronic device.

14. The game unit of claim 13, wherein said tray includes a plurality of walls.

15. The game unit of claim 13, wherein said communication means wirelessly communicates the input to the electronic device.

16. The game unit of claim 13, wherein said communication means makes mechanical contact with the electronic device.

17. The game unit of claim 13, further comprising an insert located within an insert cavity of said tray.

18. A method for operating an electronic device, comprising:
coupling an electronic device to a tray so that a display surface of said electronic device is in a horizontal position;
receiving inputs into a plurality of input devices coupled to the tray; and,
transmitting the inputs from the input devices to the electronic device.

19. The method of claim 18, wherein the tray exerts a pressure onto the electronic device.

20. The method of claim 18, further comprising connecting a connector of the tray to a data port of the electronic device.

21. The method of claim 18, further comprising plugging a jack of the tray into an audio port of the electronic device.

22. The method of claim 18, wherein the inputs are wirelessly transmitted to the electronic device.

23. The method of claim 18, wherein the input is transmitted through mechanical contact with the electronic device.

24. The method of claim 18, further comprising rotating the input devices from a concealed position to an exposed position.

25. The method of claim 18, further comprising inserting an insert into the tray before inserting the electronic device into the tray.

26. The method of claim 18, wherein the inputs are transmitted to the electronic device by a light beam.

27. A game unit for an electronic device, comprising:
a tray adapted to receive the electronic device, the electronic device including a display that displays a plurality of play areas;
a plurality of input devices coupled to said tray, each play area having a corresponding input device; and,
a coupler that couples said input devices to the electronic device.

28. The game unit of claim 27, wherein said tray includes a plurality of walls.

29. The game unit of claim 27, wherein said input devices can be rotated between an exposed position and a concealed position.

30. The game unit of claim 27, wherein said tray includes an input button that can move said input devices to the exposed position.

31. The game unit of claim 27, wherein said coupler includes a wireless receiver.

32. The game unit of claim 27, wherein said coupler includes mechanical elements that can come into contact with the electronic device.

33. The game unit of claim 27, wherein said input devices include touch pads.

34. The game unit of claim 27, further comprising an insert located within an insert cavity of said tray.

35. The game unit of claim 27, wherein said coupler includes a lamp.

36. A method for operating an electronic device, comprising:
coupling an electronic device to a tray;
displaying on the electronic device a plurality of play areas;
receiving inputs into a plurality of input devices coupled to the tray, each play area having a corresponding input device; and,
transmitting the inputs from the input devices to the electronic device.

37. The method of claim 36, wherein the tray exerts a pressure onto the electronic device.

38. The method of claim 36, wherein the inputs are wirelessly transmitted to the electronic device.

39. The method of claim 36, wherein the input is transmitted through mechanical contact with the electronic device.

40. The method of claim 36, further comprising rotating the input devices from a concealed position to an exposed position.

41. The method of claim 36, further comprising inserting an insert into the tray before inserting the electronic device into the tray.

42. The method of claim 36, wherein the inputs are transmitted to the electronic device by a light beam.

43. A game unit for an electronic device, comprising:
a tray that can be coupled to the electronic device;
a plurality of input devices coupled to said tray, each said input device transmits to the electronic device an ID that identifies said input device; and,
a coupler that couples said input devices to the electronic device.

44. The game unit of claim 43, wherein said input devices can be rotated between an exposed position and a concealed position.

45. The game unit of claim 43, wherein said tray includes an input button that can move said input devices to the exposed position.

46. The game unit of claim 43, wherein said communication device includes a wireless receiver.

47. The game unit of claim 43, wherein said coupler includes a lamp.

48. A method for operating an electronic device, comprising:
coupling an electronic device to a tray;
receiving inputs into a plurality of input devices coupled to the tray, each play area having a corresponding input device; and,
transmitting to the electronic device the inputs and an ID from each input device.

49. The method of claim 48, wherein the inputs are wirelessly transmitted to the electronic device.

50. The method of claim 48, wherein the inputs are transmitted to the electronic device by a light beam.

51. The method of claim 48, further comprising rotating the input devices from a concealed position to an exposed position.
